(19) United States
(12) Patent Application Publication
(10) Pub. No.: US 2014/0182358 A1
(43) Pub. Date: Jul. 3, 2014

(54) GAS DETECTION SYSTEM WITH MOISTURE REMOVAL

(71) Applicant: ROSEMOUNT ANALYTICAL INC., Irvine, CA (US)

(72) Inventors: Chang Dong Feng, Long Beach, CA (US); Henryk Kozlow, Calgary (CA)

(21) Appl. No.: 14/140,792

(22) Filed: Dec. 26, 2013

Related U.S. Application Data
(60) Provisional application No. 61/746,256, filed on Dec. 27, 2012.

(51) Int. Cl. G01N 1/40

(52) U.S. Cl. CPC G01N 1/4022
USPC 73/31.06; 73/31.05

(57) ABSTRACT

A gas detection system is provided. The system includes a sample gas inlet configured to receive a sample of gas and a sample chamber operably coupled to the sample gas inlet. The sample chamber has at least one gas sensor disposed therein. The gas sensor provides a gas sensor output indicative of a species of interest in the sample of gas. A controller is coupled to the at least one gas sensor and is configured to provide information related to the species of interest based on the gas sensor output. A moisture removal device is disposed to receive the sample of gas and remove moisture from the sample before the sample reaches the at least one gas sensor.

### CROSS-REFERENCE TO RELATED APPLICATION

The present application is based on and claims the benefit of U.S. Provisional Patent Application Ser. No. 61/746,256, filed Dec. 27, 2012, the content of which is hereby incorporated by reference in its entirety.

### BACKGROUND

Process/environmental gas analyzers/detectors are used in a variety of industrial processes to provide analytical solutions in order to allow processes to improve product quality, increase throughput, reduce process variability, increase safety, and facilitate regulatory compliance. Analytical instrumentation and systems for process and environmental gas analysis and toxic gas detection serve a variety of industries including: chemical processing, hydrocarbon processing, food and beverage processing, metals and mining, biogas and bio-technology, pharmaceutical and medical, waste and wastewater, pulp and paper, semiconductor, automotive, power, and textiles. Each such industry generally has specific analytical species of interest that are unique to that industry. However, all industries require precise analytical instrumentation in order to operate efficiently.

One process gas analyzer that serves the industries listed above is sold under the trade designation Model X-Stream Process Gas Analyzer, available from Emerson Process Management's Rosemount Analytical business unit, of Irvine Calif. The X-Stream Process Gas Analyzer can use a variety of sensors including, non-dispersive infrared, ultraviolet, and visible photometry (NDIR/UV/VIS), paramagnetic and electrochemical oxygen (pO₂), and thermal conductivity (TCD) sensor technologies, as well as trace oxygen (trace O₂) and trace moisture (trace H₂O) for consistent, precise process gas measurement.

Some forms of process gas measurement can be affected by trace amounts of moisture. In such cases, a trace moisture sensor is typically used to measure the amount of trace moisture present in the sample. Then, using a calibration or other suitable correction, the process gas analyzer corrects the process gas measurement based on the amount of trace moisture measured by the trace moisture sensor.

### SUMMARY

A gas detection system is provided. The system includes a sample gas inlet configured to receive a sample of gas and a sample chamber operably coupled to the sample gas inlet. The sample chamber has at least one gas sensor disposed therein. The gas sensor provides a gas sensor output indicative of a species of interest in the sample of gas. A controller is coupled to the at least one gas sensor and is configured to provide information related to the species of interest based on the gas sensor output. A moisture removal device is disposed to receive the sample of gas and remove moisture from the sample before the sample reaches the at least one gas sensor.

### BRIEF DESCRIPTION OF THE DRAWINGS

FIG. 1 is a diagrammatic view of a gas detection system with which embodiments of the present invention are particularly useful.

FIG. 2 is a diagrammatic cross sectional view of a metal oxide semiconductor-based gas sensor.

FIG. 3 is a diagrammatic view of a gas detection system in accordance with an embodiment of the present invention.

FIG. 4 is a diagrammatic view of a moisture removal device of a gas detection system in accordance with an embodiment of the present invention.

FIG. 5 is a diagrammatic view of a moisture removal device of a gas detection system in accordance with another embodiment of the present invention.

### DETAILED DESCRIPTION OF ILLUSTRATIVE EMBODIMENTS

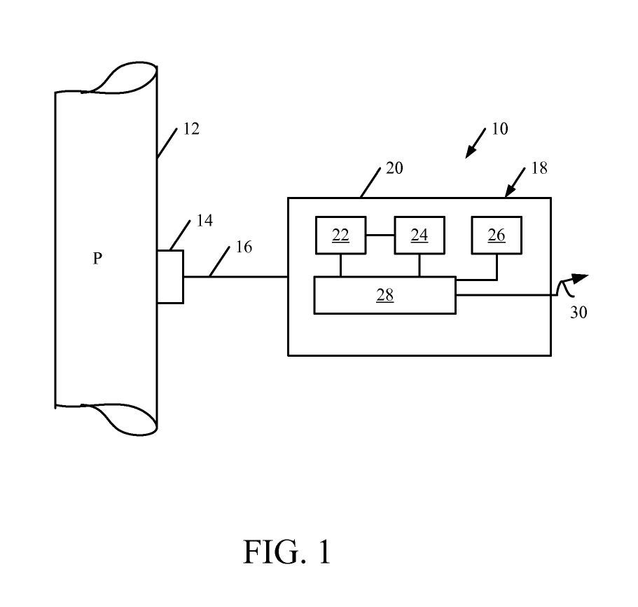

FIG. 1 is a diagrammatic view of a gas detection system with which embodiments of the present invention are particularly useful. System 10 is operably coupled to process conduit 12 via process intrusion 14. Process conduit 12 may be any conduit, pipe or fitting through which process gas flows. As such, conduit 12 may be an industrial stack, a pipe within a processing facility, or any other suitable conduit. Process intrusion 14 sealingly couples system 10 to the process gas within conduit 12. Sample line 16 conveys a portion of process gas from intrusion 14 to analyzer 18. In some instances, sample line 16 is heated to carefully maintain the temperature of the process/environment gas sample as it travels to analyzer 18. Additionally, it is generally preferred for sample line 16 to be kept relatively short such that the process analyzer is mounted relatively close to process intrusion 14.

Process analyzer 18 includes analyzer housing 20, sample flow conditioning element(s) 22, sample chamber 24, user interface 26, and controller 28. Controller 28 generally includes a microprocessor and executes software to control various flow conditioning element(s) 22. Additionally, controller 28 is coupled to one or more gas sensors disposed within sample chamber 24, such that measurements from the one or more gas sensors allow controller 28 to provide a value indicative of a presence and/or concentration of one or more constituents or species of interest within the process/environment gas sample. This output may be provided on user interface 26 and/or conveyed to a remote device via any suitable communication protocol, including without limitation, process communication protocols such as the Highway Addressable Remote Transducer (HART®) Protocol, the FOUNDATION™ Fieldbus protocol, or via suitable data communication protocols, such as Ethernet, RS-232, RS-485, et cetera, as indicated at reference numeral 30. Additionally, communication in accordance with wireless process communication protocols can also be performed, including communication in accordance with IEC62591 (WirelessHART).

At least some process gas sensors can suffer from the presence of trace moisture. In the past, these effects have been addressed by using a trace moisture sensor to quantify the trace moisture and compensate for the trace moisture's effects on the gas sensor's output. However, efforts to address the impacts of the trace moisture on the process/environmental gas output via calibration and compensation relative to the trace moisture levels did not address damage, or other deleterious effects, that such moisture may have on the gas sensors. However, this approach was accepted because any interference or change to the sample of the process/environmental gas itself could cause the sample to no longer properly reflect the gas. Given that detections levels for some gasses, such as H₂S, can be as low as 3 ppm, it would be very easy to unduly influence the sample gas constitution and thus provide inaccurate results.

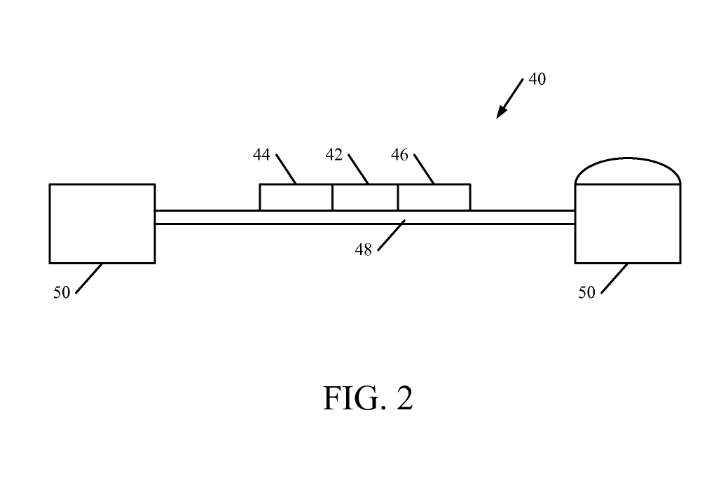

FIG. 2 is a diagrammatic cross sectional view of a metal oxide semiconductor-based gas sensor. The metal oxide semiconductor based gas sensor shown in FIG. 2 is an example of a sensor that may be used for H₂S detection and measurement. Sensor 40 generally includes a metal oxide layer 42 disposed between a pair of electrodes 44 and 46 on substrate 48. Additionally, because MOS sensors are most effective at elevated temperatures, they are often provided with a heater, such as heater 50 on the outer portion of substrate 48. Generally, in the absence of the gas of interest, the measured resistance between electrodes 44 and 46 is on the order of meg-ohms. As the gas of interest, such as H₂S, adsorbs onto MOS layer 42, the resistance between electrodes 44 and 46 drops significantly. The decrease in resistance is related to the concentration of the gas of interest.

Semiconductor metal oxide gas sensors of the type shown in FIG. 2 have been used to detect various flammable or toxic gases, such as H₂S. This type of sensor utilizes the polycrystalline structure of the sensing material (semiconductor metal oxide) and the existence of the negatively charged surface oxygen species, which controls the height of the Schottky barrier and thus the electric resistance of the material. However, when the sensor is exposed to certain reducing gases, the surface oxygen will be consumed, reducing the Schottky barrier, and the resistance, which is the sensing signal. Due to the sensing mechanism, the sensor suffers from interference from water vapors in the atmosphere. As set forth above, manufacturers of gas analyzers/detectors using this type of sensing technology have been relying on signal compensations to deal with the interference of moisture in the sensing environment.

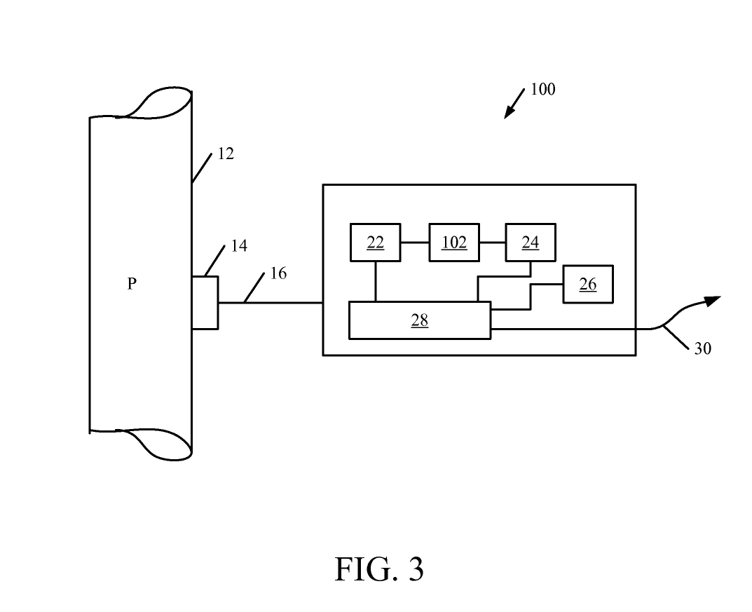

FIG. 3 is a diagrammatic view of a gas detection system in accordance with an embodiment of the present invention. System 100 bears some similarities to system 10, described with respect to FIG. 1, and like components are numbered similarly. The main difference between system 100 and system 10 is that system 100 includes a moisture removal device 102 upstream of or within sample chamber 24. Moisture removal device 102 can be placed before or within sample chamber 24 as long as the sample of gas passes through moisture removal device 102 prior to interacting with any gas sensors. Moisture removal device 102 is designed such that it does not chemically alter the sample gas, aside from removing undesirable trace moisture. Moisture removal device 102 generally provides a relatively cool, inert surface that causes moisture in the sample gas to condense out of the sample. Preferably, the temperature of the cool surface is selected to be slightly above the freezing point of water at the operating pressure of the gas sample. Thus, if the operating pressure is the standard pressure (14.696 psi, 1 atm) the temperature of the cool surface would be slightly above 32° F. Further, the material of the cool surface may be selected to be any material that is inert to the species of interest. Further, such material may include suitable metals due to their higher thermal conductivities and specific heat. Suitable examples of the material for the relatively cool surface include polytetrafluoroethylene (PTFE) and gold. The relatively cool surface can be cooled in accordance with any suitable cooling techniques now known or later developed. Specifically, the cooling may be done using a known compressor/evaporator heat pump system to draw heat from the relatively cool surface and convey it elsewhere. Additionally or alternatively, one or more known Peltier devices can be used to provide thermoelectric cooling to the relatively cool surface.

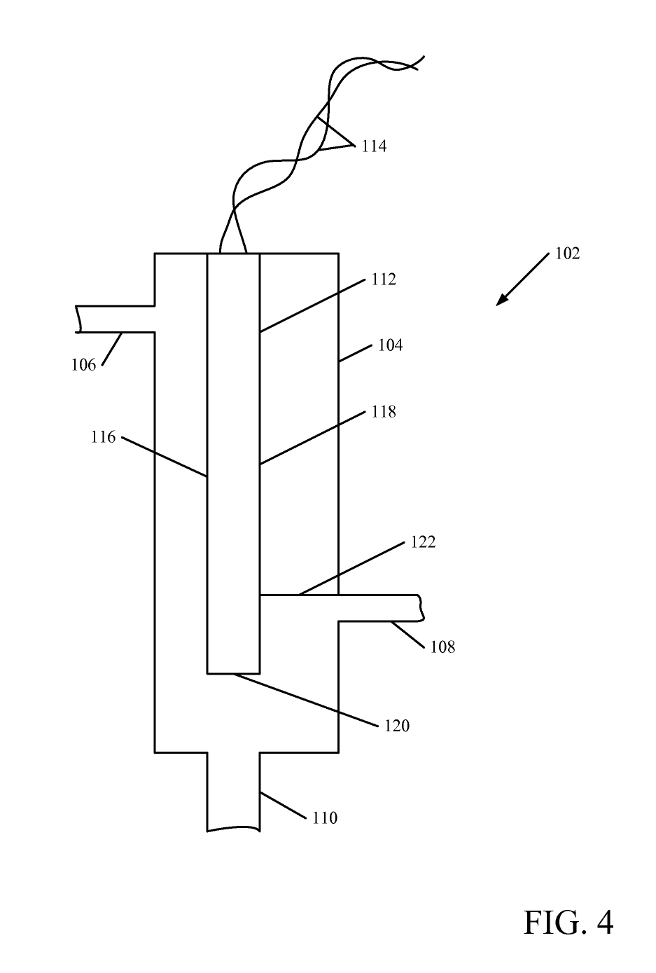

FIG. 4 is a diagrammatic view of a moisture removal device of a gas detection system in accordance with an embodiment of the present invention. Moisture removal device 102 has a housing 104 with an inlet 106, an outlet 108, and a water drain 110. In the embodiment illustrated in FIG. 4, a thermoelectric cooler 112 is provided with lead wires 114 that operably couple to the gas analyzer. Thermoelectric cooler 112 has a cool side 116 and a hot side 118. Application of a current to thermoelectric cooler 112 generates a heat flux between cool side 116 and hot side 118. The amount of current provided to cooler 112 controls the amount of heat flux generated by cooler 112. Additionally, one or more temperature sensors can be coupled to cool side 116 and/or hot side 118 such that the controller of the gas analyzer can monitor and control operation of cooler 112.

Sample gas entering housing 104 through inlet 106 will encounter cool side 116 as it travels downward along surface 116. As the temperature falls, water vapor present in the sample condenses on cool side 116. The condensed water descends cool side 116 with the assistance of the sample gas flow and gravity and drips from cool side 116 to drain 110. Drain 110 may accumulate water during analysis and then purge such water after analysis such that a closed system is maintained during analysis/detection. The sample gas flows beyond bottom edge 120 and begins to ascend along hot side 118. However, the sample gas encounters a flow diverter that forces the sample gas through outlet 108 and ultimately on to the sample chamber 24 (shown in FIG. 3). However, as set forth above, some embodiments of the present invention include positioning moisture removal device 102 within sample chamber 24. Additionally, if desired, the amount of water accumulated during analysis/detection can be measured and combined with sample gas flow information to provide an indication of moisture present in the original sample. Such quantity may be of interest in some analytical contexts. Moreover, in some situations where a trace moisture sensor is used, the amount of water accumulated during analysis/detection can be compared to a trace moisture content measured in the original sample to verify and/or calibrate the trace moisture sensor.

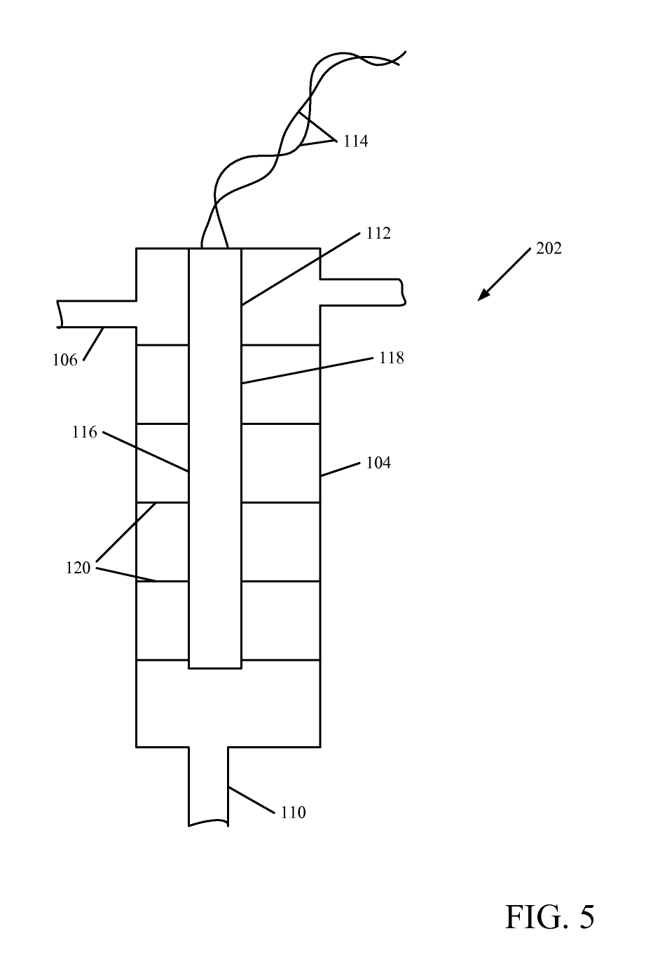

FIG. 5 is a diagrammatic view of a moisture removal device of a gas detection system in accordance with another embodiment of the present invention. Moisture removal device 202 bears some similarities to moisture removal device 102 (shown in FIG. 4) and like components are numbered similarly. Moisture removal device 202 differs from moisture removal device 102 in that the dried sample gas is caused to ascend the substantially entire hot side 118 of thermoelectric cooler 112. Additionally, a number of flow walls 120 extending between housing 104 and thermoelectric cooler 112 to cause the sample gas to follow a tortuous or serpentine path along both the cool side 116 and the hot side 118. This flow path causes a more significant thermal interaction between the sample gas and thermoelectric cooler 112. Additionally, in some embodiments, the length of the flow path along the hot side is substantially the same length as the length of the flow path along the cool side. This allows the sample gas to recover most if not all of the heat lost as it passed along the cool side. Such thermal recovery can help ensure that the sample entering the sample chamber and interacting with one or more gas sensors is more closely representative of the original sample gas. While a heater could be used to simply heat the sample gas to its original temperature, it is more efficient to use both sides of the thermoelectric cooler. Further, in embodiments where cooling is provided using an evaporator/compressor combination, the sample gas could be made to flow proximate the evaporator coil during cooling and the condenser for heat recovery.

Although the present invention has been described with reference to preferred embodiments, workers skilled in the art will recognize that changes may be made in form and detail without departing from the spirit and scope of the invention.

What is claimed is:

1. A gas detection system comprising:
a sample gas inlet configured to receive a sample of gas;
a sample chamber operably coupled to the sample gas inlet, the sample chamber having at least one gas sensor disposed therein, the at least one gas sensor providing a gas sensor output indicative of a species of interest in the sample of gas;
a controller coupled to the at least one process gas sensor and configured to provide information related to the species of interest based on the gas sensor output; and
a moisture removal device disposed to receive the sample of gas and remove moisture from the sample before the sample reaches the at least one gas sensor.

2. The gas detection system of claim 1, wherein the gas sensor is a metal oxide semiconductor-based sensor.

3. The gas detection system of claim 2, wherein the gas sensor is an H₂S sensor.

4. The gas detection system of claim 2, wherein the gas sensor has a polycrystalline structure of sensing material and the existence of a negatively charged surface oxygen species controls a height of a Schottky barrier and an electrical resistance of the sensing material.

5. The gas detection system of claim 1, wherein the moisture removal device has a surface maintained at a temperature selected to cause moisture in the sample of gas to condense onto the surface.

6. The gas detection system of claim 5, wherein the surface is relatively inert.

7. The gas detection system of claim 5, wherein the surface is a cool surface of a thermoelectric device.

8. The gas detection system of claim 7, wherein the moisture removal device is configured to cause the sample of gas to flow along a hot side of the thermoelectric device.

9. The gas detection system of claim 8, wherein a length of flow path along the cool side of the thermoelectric device is substantially equal to a length of flow path along the hot side of the thermoelectric device.

10. The gas detection system of claim 5, wherein the surface is cooled by a compressor/evaporator heat pump system.

11. The gas detection system of claim 1, wherein the moisture removal device includes at least one flow wall configured to cause the sample of gas to follow a tortuous flow path through the moisture removal device.

12. The gas detection system of claim 1, wherein an amount of water condensed in the moisture removal device is related to a trace moisture value for the sample of gas.

13. The gas detection system of claim 1, wherein the moisture removal device is interposed between the sample gas inlet and the sample chamber.

14. The gas detection system of claim 1, wherein the moisture removal device is disposed within the sample chamber.

15. A method of analyzing/detecting gas, the method comprising:
obtaining a sample of gas;
contacting the gas with a surface having a temperature selected to cause water vapor in the sample of gas to condense thereon to provide a drier sample of gas;
conveying the drier sample of gas to at least one process gas sensor to obtain a gas sensor measurement; and
providing an indication relative to the gas based on the gas sensor measurement.
